(19) United States
(12) Patent Application Publication
(10) Pub. No.: US 2026/0361618 A1
(43) Pub. Date: Nov. 12, 2026

(54) METHODS AND APPARATUS FOR ORGANIZING, VISUALIZING, AND PREDICTIVE MODELLING OF ROUTING AND OTHER CONTROL PLANE INFORMATION IN A COMMUNICATION NETWORK

(71) Applicant: Selector Software, Inc., Santa Clara, CA (US)

(72) Inventors: Sunanda Kommula, Cupertino, CA (US); Nitin Kumar, Fremont, CA (US); Aravind Prabhakar, Woburn, MA (US); Siva Gaggara, Hyderabad (IN)

(21) Appl. No.: 19/204,240

(22) Filed: May 9, 2025

(51) Int. Cl. H04L 41/22; H04L 43/045; H04L 67/75

(52) U.S. Cl. CPC H04L 41/22; H04L 43/045; H04L 67/75

(57) ABSTRACT

This disclosure pertains to computer-assisted methods, apparatus, and systems for efficiently organizing, modelling, visualizing, and predictive modelling of routing and other control plane data in a communication network.

### FIELD OF THE INVENTION

This disclosure pertains to computer-assisted methods, apparatus, and systems for efficiently organizing, visualizing, and modelling of routing and other control plane data in a communication network.

### BACKGROUND

Presently, there is a critical blind spot in communication network management. Particularly, there is no efficient manner for a network operator or analyzer to monitor, understand, and/or visualize control plane data, such as routing information, traffic load distribution, network node health/status, etc. for a large scale network. Rather, the only option today for such analysis is to review lists and tables of control plane data, which is extremely inefficient and not user-friendly. The problem is even further exacerbated when the network operator wishes to isolate for analysis such network control plane parameters for a single one of its many customers.

For instance, a large scale network operator, such as an Internet Service Provider (ISP), may have tens, or even hundreds, of thousands of customers, including large scale businesses, who rely on the ISP for connectivity to and through the Internet, which connectivity is crucial to their business operations.

Network operators typically enter into Service Level Agreements (SLAs) with their customers in which they guarantee their customers certain levels of service. Such guarantees, for instance, typically promise level of service guarantees (e.g., 99.999% connectivity) for certain maximum levels of traffic (user data and/or control plane data) from the particular customer. When a customer's user plane or control plane traffic exceeds the specified level, the guaranteed level of service may change to a different level, disappear entirely, or come at a higher cost to the customer.

Even aside from the SLAs, network operators must know how much traffic is flowing through the nodes and edges (i.e., links) of its network to determine when nodes are overloaded, nodes are faulty, edges are overloaded or faulty, additional nodes or edges need to be added to handle the increased traffic, etc.

While most of the control plane data that is needed to monitor network health and manage a large scale network is readily available (e.g., routing tables, BGP update reports, etc.), such data is voluminous and difficult to parse in a useful manner. Organizing such data for presentation that is easy for humans (or even computers) to digest, visualize, and/or analyze for purposes of determining how to run a network (e.g., find and repair faulty network components, determine when and where to add network resources, etc.) is a daunting task that has not been adequately addressed to date. Furthermore, there is a need to enable network operators to test what-if scenarios (e.g., for locating the sources of network connectivity problems, for determining how to solve network connectivity problems, for deciding what additional resources are necessary to add traffic capacity when needed, to determine what resources may be eliminated if network user traffic decreases, etc.) in a model of the network so as not to have to take the network out of operation to do so.

These issues are significant because network downtime and performance issues directly impact business operations, customer experience, and revenue. Service providers and enterprises invest millions of dollars in network infrastructure, but often lack the tools to fully visualize and optimize their routing architectures.

To generally provide its customers with fast, smooth, and error-free access to the Internet and between the customer's own nodes that connect through the ISP's network, such ISPs must monitor the condition of their networks continuously to assure proper operation, detect and remedy failed nodes, detect traffic conditions and reroute traffic as needed to alleviate high traffic conditions, etc.

Part of this process of maintaining and monitoring a communication network is to maintain a routing table (or Routing Information Base or RIB, for short). Particularly, in a mesh network, such as the Internet, a routing table is developed over a period of time that dictates how any given packet will be routed through the network from any given source node to any given destination node. In addition to the Internet RIB, each customer has its own private RIB with hundreds of thousands of RIB entries. With tens of thousands of customers, an ISP's RIB data can comprise several hundred million RIB entries. More particularly, to build the RIB, the nodes of the network exchange control plane messages (layer 1, 2, and/or 3 messages, such as prefix advertisement and discovery messages, etc.) whereby the nodes, over time, determine the complete topology of the network, including, for instance, which nodes are directly coupled to which other nodes and the cost of each connection between adjacent nodes.

FIG. 1 is a graphical representation of an exemplary network topology 10. It shows every node in the network as well as the links between the nodes (hereinafter sometimes referred to as edges) and the cost of each link. In this very simple example, there are 11 nodes, namely, nodes A through K. Each arrowed line represents a direct communication link between two nodes (i.e., two nodes that can communicate directly with one another without using an intermediate node, sometimes referred to as adjacent nodes). The arrows indicate the directions of the links, and the number in the middle of each line represents the relative cost of the link.

Once the network topology is mapped and known by each node, each node can build a Routing Information Base (RIB) which dictates to which other network node the node should transmit a data packet intended for any particular destination address. Particularly, each data packet typically includes within the packet a destination address (i.e., the identity of the destination node and/or device). The node determines the nexthop for a packet having a certain destination address (i.e., the next node to which it should transmit the packet) based on the RIB.

As new nodes are added or old nodes are removed from the network, update messages are exchanged between the nodes of the network so that all of the nodes can continuously update their pictures of the network topology and their respective routing tables.

Referring again to the network topology diagram of FIG. 1, it also demonstrates a route, represented by the dashed line 12, dictated by the RIB for data originating at a first, source device 14 (e.g., a cellular telephone) that connects to the network via network node A and a second, destination device 16 (e.g., a server) that is connected to the network through node K. As can be seen, using an algorithm such as the well-known Dijkstra's algorithm, the RIB dictates a path that goes from node A to node D, then from node D to node E, then from node E to node F, and, finally, from node F to node K.

Route Reflectors (RRs) are routers within a network that reflect routes learned from BGP peer routers. They are often employed to reduce the amount of control plane traffic in the network necessary to maintain and update the RIBS throughout the network. FIG. 2 helps illustrate the concept of RRs. Particularly, a RR may be assigned a plurality of provider routers (e.g., PEs) for which it is responsible for maintaining the RIB information. More specifically, all of the PEs assigned to a given RR form a peering relationship with only that RR to build their RIBs, rather than with every other PE. Thus, that RR contains routing information for all of its PEs, and each of those PEs can build its own RIB from the information that it obtains from its associated RR. Note that, often, in such schemes, a PE may be assigned to multiple RRs for redundancy and/or other purposes.

In the example shown in FIG. 2, the ISP's network 201 comprises 20 PE routers 203 plus 13 RRs 205 (note that not all of the PEs and RRs are labelled with their respective reference numbers in order not to obfuscate the drawing with excessive reference numerals). Each RR 205 peers with a set of PEs 203 (in this example, two, three, four, or five PEs, depending on the particular RR). The group of PEs that communicate with any given single RR is herein called the peer group of that RR. Each PE 203, being an edge router, is coupled to at least one CE (Customer Edge) router 207 of another network (e.g., the Internet or the VPN of a customer of the ISP).

Thus, instead of N PE routers 203 establishing a full mesh of sessions with N-1 other routers in the network (where N is an integer representing the total number of routers in the ISP's network), each PE 203 establishes a session to exchange routing information only with the one or more RRs to which it is assigned (i.e., of which it is a member of that RR's peer group).

Service providers connect customers globally using layer-3 VPNs, relying on a carefully designed routing hierarchy. The RRs are organized to distribute routing tables among multiple devices, ensuring no single RR becomes overloaded while maintaining complete connectivity information for all customer locations. When customers connect from various global Points of Presence (PoPs), routing information travels through a carefully designed hierarchy, typically as follows: (1) customer edge routers (CEs) connect to local provider edge routers (PEs); (2) PEs communicate with route reflectors (RRs); (3) RRs exchange information with other route reflectors (often across geographic regions); (4) information propagates to from the RRs to the PEs near destinations; and (5) information finally reaches the customers' CEs (and may be further propagated to other network nodes throughout the customers' local networks).

In a large-scale ISP network, there might be hundreds of RRs 205, each serving a geographical area as determined by the ISP, wherein hundreds of millions of routes are being exchanged via the RR network hierarchy. Each RR 205 peers with several PE routers 203 to learn Internet prefixes reachable from those PEs and resolve the best nexthop PE 207 for each prefix. It then reflects these routes to all the PEs 203 that are in its peer group.

Thus, it can be surmised that, in a network utilizing RRs, the number of perspectives is proportional to the number of RRs in the ISP's network, rather than the number of PEs in the ISP's network. Hence, for instance, if we assume an ISP network with 5000 PEs connected to 800 RRs, the user of RRs can reduce the total number of prefixes that must be stored from 5 billion (5,000 PEs*1 million Internet prefixes) to 800 million (800 RRs*1M Internet prefixes).

### SUMMARY

In an embodiment, a method of displaying customer-centric control plane information about a communication network comprises: obtaining data defining the control state of the communication network; selecting a customer of the network; determining from the data defining the control state of the communication network a subset of the nodes of the network and a subset of the edges of the network being utilized in support of data of the selected customer; generating a visual display of a portion of a topography of the network including visual representation of only the nodes of the network being utilized in support of data of the selected customer and visual representations of only the edges of the network that comprise connections between the displayed nodes; with respect to each visual representation of an edge of the network, indicating via a first visual attribute of the visual representation of the edge a relative amount of control plane data flowing in the edge relative to the other edges in the display; with respect to each visual representation of an edge of the network, indicating via a second visual attribute of the visual representation a level of the control plane data flowing in the edge relative to a first threshold; and, with respect to each visual representation of a node of the network, indicating via an attribute of the visual representation of the node a level of control plane data stored in the node.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements.

FIG. 1 is a diagram illustrating an exemplary network topology and packet route through the network;

FIG. 2 is a diagram illustrating an exemplary network topology of a communication network employing reflector routers;

FIG. 3 is a diagram illustrating a customer-centric visual representation for a single customer of control plane information in a network provider's network;

FIG. 4 is a diagram illustrating a customer-centric visual representation for a single customer of control plane information in a network provider's network showing traffic levels, and conditions for network edges and network nodes in accordance with embodiments;

FIGS. 5A-5G are diagrams showing a few exemplary graphical user interfaces containing network control plane data that may be obtained when a user clicks on certain elements in the diagrams of FIG. 4; and

FIG. 6 is a flowchart illustrating an exemplary operation for constructing the visualization tool of FIG. 4 in accordance with one specific exemplary embodiment.

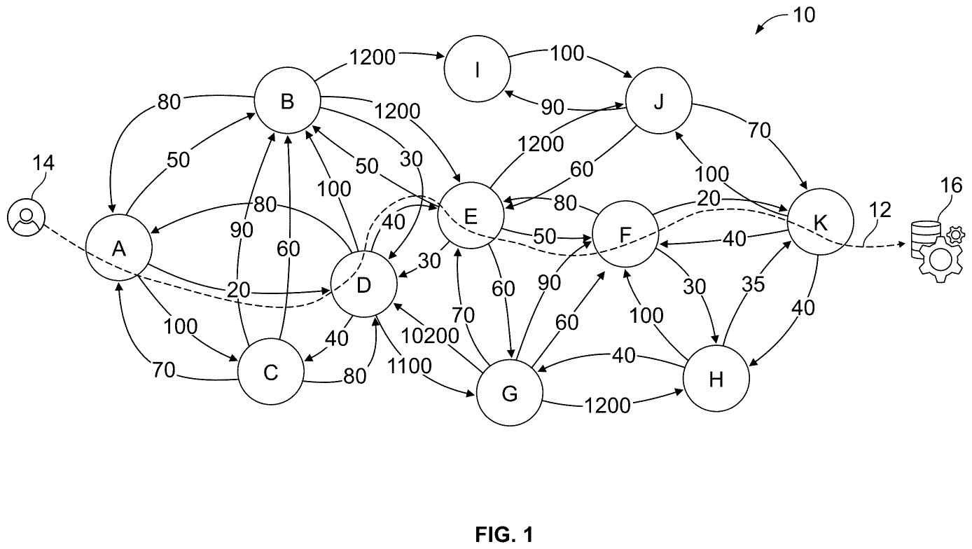

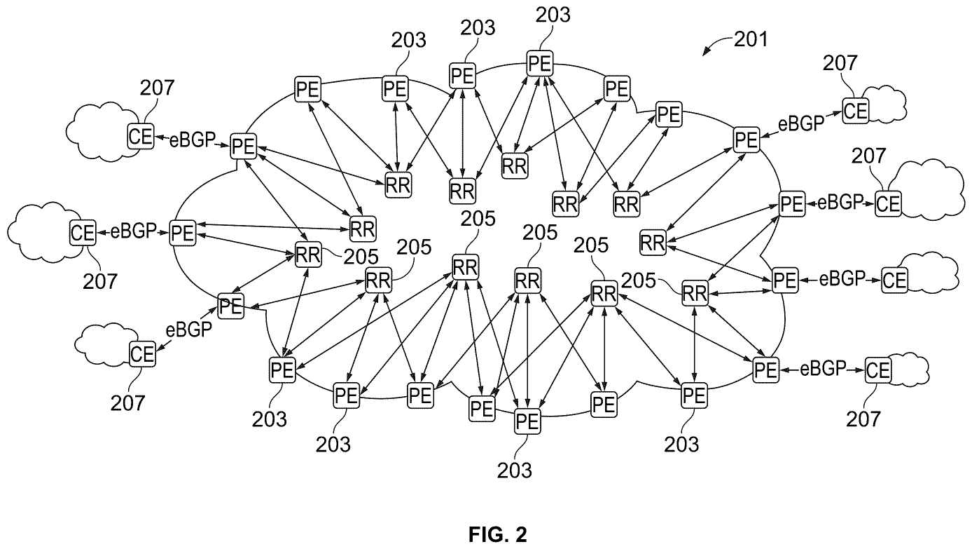

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obfuscate the following description. Further, embodiments and examples not specifically described herein may be practiced in lieu of, or in combination with, the embodiments and other examples described, disclosed, or otherwise provided explicitly, implicitly, and/or inherently (collectively “provided”) herein.

U.S. patent application Ser. No. 18/434,963, owned by Selector Software, Inc., the applicant of the present patent application is incorporated herein in full by reference. It discloses methods and apparatus for storing, maintaining, monitoring, and querying a database from which the status of a communication network, including the RIB for the entire network, can be determined. One use of such a system is for historical analysis of a network for determining and/or diagnosing the causes of detected network errors or performance degradations, such as determining the identity of a faulty network node. Since a modern large scale network could easily comprise thousands of nodes (typically comprising a plurality of smaller, heterogeneous topologies), when a message is not received properly at the destination node, it often is extremely challenging to determine which node in the network caused the fault and needs attention.

In order to identify a faulty node, operations teams employed by the network operator must examine the network topology and spot any inconsistencies along the paths from the source device to the destination device, and thereby determine which parts of the network need to be triaged in depth. U.S. patent application Ser. No. 18/434,963 makes the process of identifying a faulty node much easier by providing a system that can quickly create a model of the state of the network at a particular point in time in the past, which model a network analyst can examine to determine the route that a packet would have travelled in the network at any given time from a source node to a destination node and then drill down into detailed data about each node in that path to find the source of a network fault. All of this can be done in the model without any need to take the actual network offline or otherwise require any perturbations of the actual network.

U.S. patent application Ser. No. 18/600,223, also owned by Selector Software, Inc., also is fully incorporated herein by reference. It adds to the innovations of U.S. patent application Ser. No. 18/434,963 and discloses methods and apparatus for storing, maintaining, monitoring, and querying a database from which the status of a communication network, including the RIB for the entire network, can be determined, and from which potential future modifications to a network can be experimentally tested to forecast network operations under such proposed modifications without perturbation of the actual network.

Network service providers, such as ISPs, connect customers globally using layer-3 VPNs, relying on a carefully designed routing hierarchy. Route Reflectors (RRs) are organized to distribute routing tables among multiple devices, ensuring no single reflector becomes overloaded while maintaining complete connectivity information for all customer locations.

As previously noted, when customers connect from various global Points of Presence (PoPs), routing information travels through a carefully designed hierarchy, typically as follows: (1) customer edge routers (CEs) connect to local provider edge routers (PEs); (2) PEs communicate with route reflectors (RRs); (3) RRs exchange information with other route reflectors (often across geographic regions); (4) information propagates to from the RRs to the PEs near destinations; and (5) information finally reaches the customers' CEs (and may be further propagated to other network nodes throughout the customers' local networks) .

The present invention is a system (e.g., a software application) that generates a Graphical User Interface (GUI) that is a visual representation of the control plane state of a network on a display device, such as a computer monitor, that is intuitive and user-friendly and which provides numerous opportunities to drill down into the data shown in the higher level visualizations.

In the present invention, normally invisible network control plane information is organized and presented in an intuitive, interactive graphical user interface paradigm that emulates an automobile highway system mapped to geographic locations (sometimes referred to herein as the Control Plane Highway or CPH). In this paradigm, the edges of the network (the communication links between nodes) can be thought of as roads, while the nodes of the network (e.g., PEs. CEs, RRs) can be thought of as locations (e.g., exit ramps on the highways or cities interconnected by a highway system). Unlike traditional tools that present routing information in technical tables or static diagrams, the Control Plane Highway approach correlates distributed routing data from hundreds of devices into a unified, customer-specific view without requiring specialized query expertise. It uniquely visualizes the complete journey of routing information from customer edge to provider edge through route reflectors and back with dynamic indicators for route volume and health. The Control Plane Highway makes routing architecture accessible to both specialists and non-technical stakeholders, while offering predictive “what-if” analysis capabilities that transform network management from reactive troubleshooting to proactive optimization.

In a preferred embodiment, the CPH displays customer-centric information. That is, in an embodiment, only the nodes and edges storing or carrying RIB data for a single selected customer are seen in the visualization. All other nodes and edges of the network that are not involved in that customer's RIB data are not presented for view. On the other hand, as will be discussed in more detail below, in a preferred embodiment, for those nodes and edges that are shown, the visualization shows information representative of the total usage of those edges and nodes by all customers. This is so because it is envisioned that the most common use case for the CPH paradigm is probably when a network operator wishes to analyze network performance for a particular customer. In such a case, only the nodes and edges used by that customer are of interest to the analysis. However, the network's performance over those edges and nodes is a function of the overall usage of those nodes and edges by all customers.

This customer-centric visualization reveals the complete journey of routing data from its origins at various entry points to its distribution across all customer locations. The topology showcases the dynamic propagation of routes as they flow through the hierarchical system, highlighting potential bottlenecks, redundant paths, and the efficiency of the route distribution architecture. By visualizing the control plane as a highway system, complex routing data becomes intuitively accessible. Instead of being scattered across multiple databases and router tables requiring specialized query language knowledge, information appears as an interactive map with nodes (network elements) and edges (sessions) that almost anyone can understand.

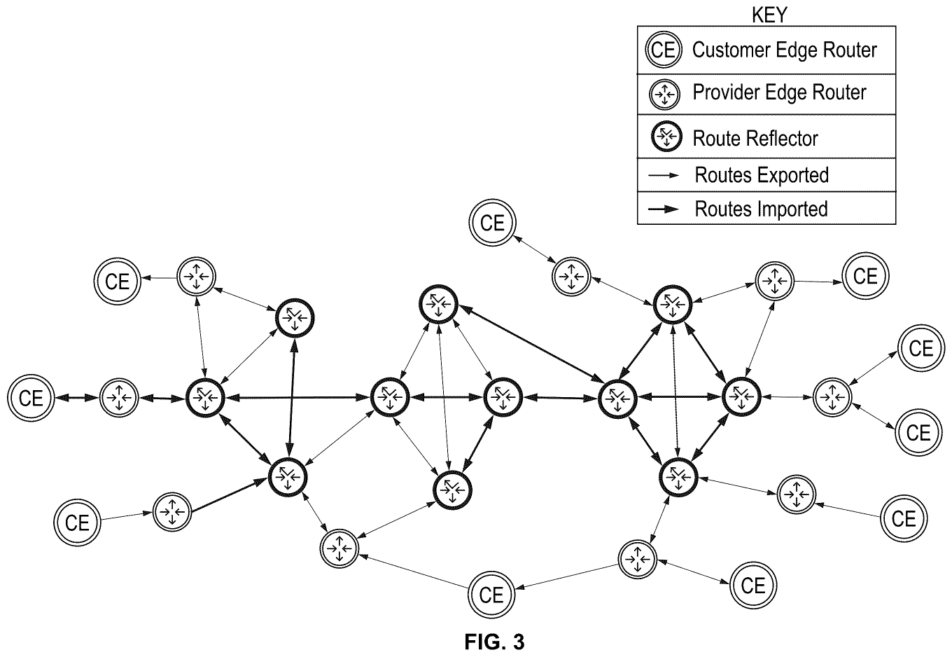

FIG. 3 is a diagram illustrating one example of the basic concept of the Control Plane Highway visualization paradigm for visualizing control plane data. FIG. 3 is a customer-centric view of the network. In essence, this means that it displays only the ISP nodes (e.g., PEs and RRs), customer nodes (CEs), and edges through which one particular customer's data flows. Particularly, an ISP's network typically will comprise many more PEs, RRs, and edges than are shown in the customer-centric visualization of FIG. 3 in order to service many customers, but the CPH will show only those nodes and edges relevant to the single customer of interest. The CPH visualization paradigm may be used to show the control plane data for any subset of customers at a time (including all customers, i.e., the entire ISP network). However, it is expected that, for many of the cases for which an ISP may wish to analyze control plane data, it will be interested in looking at that data on a single customer basis. Accordingly, the disclosure will mostly use single customer exemplary embodiments.

It further should be understood that, while the control plane highway visualization paradigm may be used to visualize the entire network, this will likely be a rare use case, as a visual representation of control plane information for an entire large scale network typically will comprise a great deal of information that may be impractically large for analysis purposes, which may defeat one of the primary purposes of the present invention of presenting the control plane data to a user in an easily digestible manner.

In the CPH, the different types of nodes in the network, e.g., PEs, RRs and CEs, are distinguished from each other by different border colors. Specifically in this example, all of the network nodes are visually represented by circles wherein the different types of nodes are distinguished by the border color. Specifically, PEs are distinguished by pink borders, RRs are distinguished by blue borders, and CEs are distinguished by black borders. Border color is merely one example of a visual attribute of the node that can be used to differentiate the different types of nodes. Any other reasonable color scheme or other visual distinguishing scheme that makes it fairly easy to visually distinguish the different types of nodes may be implemented, including, for instance, dot-dash patterns, other patterns, a number of parallel lines forming the line, a number, letter, or other symbol appearing somewhere in the node, fill patterns, cross-hatching patterns, and/or simply labelling them PE, CE, and RR, respectively.

The edges of the network (i.e., communication links between the nodes) are represented by solid arrowed lines. Note that, except as otherwise stated herein, the term line is used very broadly herein and is intended to include both straight lines and curved lines, dashed lines, dotted lines, squiggly lines, etc. The arrows indicate the direction of potential control plane traffic flow between the two nodes connected by an edge. As can be seen, in a typical network, most nodes will have a bidirectional connection (insofar as control plane data usually is exchanged in both directions between nodes). However, sometimes control plane data may travel in only one direction.

As will be discussed in more detail below, a visual attribute of each edge (arrowed line) is set as a function of the volume of control plane data on that edge, e.g., the number of routes being exported, reflected, imported, and/or exchanged. In the examples discussed in this specification that visual attribute is the thickness of the line. However, it may be any reasonable visual attribute, including, for instance, color, dot-dash pattern, other pattern, the number of parallel lines forming the line, a number, letter, or other symbol appearing somewhere in the line, the line may be squiggly with the rate of squiggliness being the visual attribute, fill patterns, cross-hatching, etc.

Since, the idea of this embodiment is to present to the observer an instantaneous picture of the state and health of the network, that volume may be calculated based on the number of routes exported, reflected, and/or imported over a short period of time preceding the current instant of time (e.g., 10 milliseconds). However, that period may be selectable by the user and may be changeable to any period desired.

Also note that, the CPH as seen in FIG. 3 shows only information about control plane traffic, and has nothing to do with user data. In order to achieve the goal of making the visualization as simple as possible while still presenting all of the useful control plane information, no user plane information is represented in this embodiment.

Even further, note that the control plane highway visualization of FIG. 3 shows only the nodes and edges relevant to the particular customer of interest. It does not show any nodes or edges of the network that carry control plane data of only customers other than the customer of interest. On the other hand, the thickness attribute of each edge (which thickness represents the volume of RIB data on that edge) is a function of the total RIB data of all customers on that edge, and not just the RIB data of the single customer of interest. Of course, in alternate embodiments, the thicknesses of the edges may be used to represent the volume of customer specific RIB data, if that information is more important to the particular task at hand. In embodiments, the user may be allowed to toggle between both views at will. In some embodiment, the thickness of the edges may be infinitely variable as a function of the volume of RIB data on that edge (e.g., the edge with the most RIB data is the thickest, the edge with the second most RB data is the second thickest, etc.). In other embodiments, the thicknesses of the edges may be limited to a preset number of possible thicknesses (such that multiple edges carrying similar, but different, amounts of RIB data have the same thickness). In some embodiments, the thickness of the edge may be set as a function of predetermined threshold values. In other embodiments, the thicknesses may be set relative to each other. For example, if the edge with the most RIB data has a volume of X exchanges per second and there are four thicknesses, then edges with a volume of less than ¼X are assigned a thinnest thickness, edges with a volume between ¼X and ½X are assigned a second thinnest thickness, edges with a volume of between ½X and ¾X are assigned a third thinnest thickness, and edges with a volume greater than ¾X are assigned a fourth, thickest thickness.

In embodiments, each network node in the visualization in the ISP's network may be “clickable” to reveal even more relevant control plane data to the user. Note that the CEs are the customer's nodes and are not part of the ISPs network. They are critical elements shown in the visualization, but may not be clickable to gain additional information because they are not part of the ISP's network and, therefore, their data may not be accessible to the ISP. In any event, for example, by clicking on a PE or RR icon in the visualization, one may be taken to any number of different additional GUIs providing much more specific control plane information about that node, such as, e.g., (1) traffic volume, such as routes exported, routes imported, and/or routes reflected, (2) junction configuration, such as equipment settings and state, (3) resource utilization, such as CPU and memory usage (equivalent to intersection capacity), (4) customer impact such as how much routing table space each customer occupies, and (5) overall health indicators, such as Key Performance Indicators (KPIs) that evaluate node performance.

In addition, in embodiments, each edge (typically including the edges between the customers' CEs and the ISPs PEs) also is clickable to reveal more relevant control plane data about that edge. Clicking on any road segment may reveal, for instance; traffic patterns, such as routes and updates flowing between the two nodes connected by the edge, (2) directional flow, such as information exchanged in both directions between provider edge routers, route reflectors, and customer equipment, and (3) connection health data, such as protocol operational status between node pairs (note that BGP session status reflects and impacts multiple customers).

The highway metaphor also naturally extends to trend analysis and capacity planning, such as: (1) historical traffic trends, such as normal export patterns from customer locations, (2) anomaly detection, such as unexpected spikes or dips in route counts, (3) predictive modelling, such as forecasting future routing table growth, and (4) capacity thresholds, such as identifying when route reflectors (particularly virtual ones with limited resources) approach saturation points.

In embodiments, the system also allows an operator to create what-if analyses for testing out potential network topology changes or other changes. For instance, an operator can take any piece of data available in the visualization (including the drill-down data available via clicking on any of the nodes or edges of the network) and change one or more values. The system will calculate how that change would affect the network and then update the CPH visualization of the network under that potential scenario for the operator to see and analyze as desired. For instance, a user can go in and change the amount of RIB data on an edge to quadruple its value to see what effect it would have on the network. In an example, it might cause that edge color to be changed from yellow to red. In essence, a user can use the CPH to create virtual simulations of network conditions to analyze the impact of changes in individual edges and routers of the network, e.g., changes to traffic load, buffer load, traffic capacity, buffer capacity, etc.

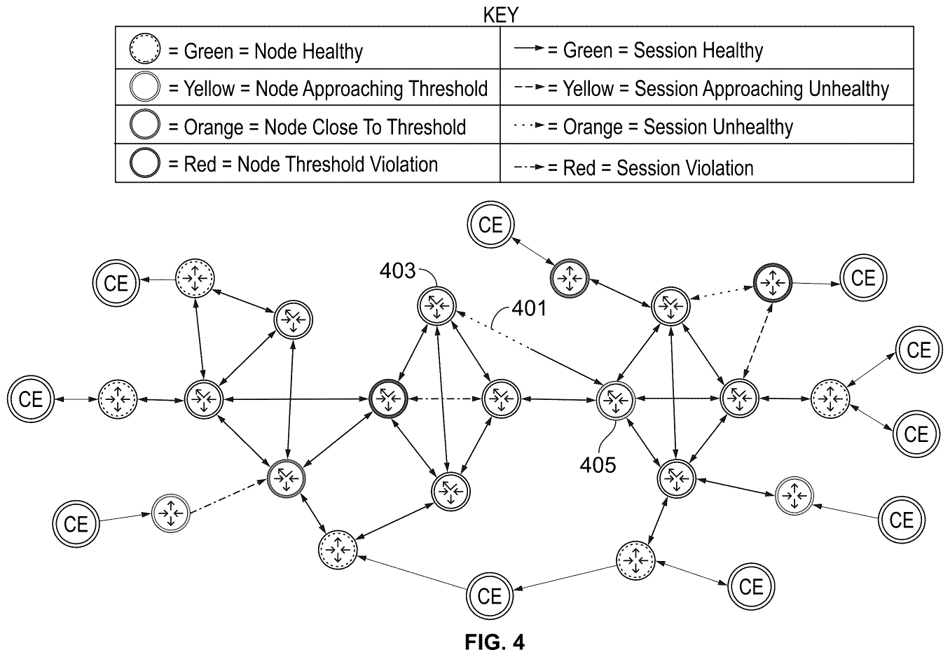

FIG. 4 is a diagram illustrating another, even more robust, example of the Control Plane Highway visualization paradigm for visualizing control plane data in accordance with embodiments.

This embodiment may include essentially all of the features discussed above in connection with the embodiment of FIG. 3, but with the edges and nodes being even further visually coded by another visual attribute to represent in an easily digested visual manner even more control plane information. Particularly, in this embodiment, each edge and router comprises additional color-coding to indicate the health of the node or edge. Again, color is merely one example of a visual attribute of the visual representation of the node or edge that can be used to indicate information about a control plane attribute of the edge or node. Other possible visual attributes include dot-dash pattern, grayscale, cross-hatching pattern, numbers, letters, or symbols placed within the visual representation of the node or edge, fill pattern, border pattern, etc.

More specifically, with regard to the edges of the network, the colors of the edges may represent how close the volume of control plane traffic on that edge is to a relevant threshold. The threshold may be the maximum traffic capacity of the edge, for instance. In the exemplary embodiment represented in FIG. 4, the edges between CEs and PEs are not color-coded, indicating that BGP session data for those edges is not made available to the ISP. This may be due to customer preference or for other reasons. However, in many cases, that data may be available to the ISP, in which case those edges may also be color-coded.

Similarly to the discussion above of FIG. 3, in some particular examples, the thresholds, the line thicknesses, and the line colors may correspond to the over-all traffic volume capacity of the edge for all customers. In other examples, they may correspond to the traffic of the single customer of interest (e.g., the threshold may be the traffic volume paid for by the particular customer, e.g., according to that customer's SLA). The user may be allowed to toggle between the two settings.

Any number of colors may be used to represent various states of the edges. For instance, in the embodiment illustrated by FIG. 4, there are four different colors, e.g., (1) green indicating that the volume is less than 80% of the threshold (and thus the edge is considered to be healthy since there is still plenty of traffic capacity that is not yet being utilized), (2) yellow indicating that the traffic volume is between 80% and 90% of the threshold (thus indicating that the edge traffic is approaching the threshold and perhaps needs attention), (3) orange indicating that the traffic volume is between 90% and 100% of the threshold (thus indicating that the edge traffic is approaching the threshold), and (4) red indicating that the traffic volume has surpassed the threshold (e.g., thus indicating that the traffic capacity of the edge has been exceeded and packets may be getting dropped).

For edges that support two way traffic, the volume of traffic in each direction may be represented separately. For instance, in the FIG. 4 embodiment, note that edge 401 is half orange and half green. The half closer to node 405 is green, while the half closer to node 403 is orange. This indicates that the traffic flowing from node 405 to node 403 over the edge 401 is between 90% and 100% of the threshold, while the traffic flowing from node 403 to node 405 is below 80% of the relevant threshold.

With respect to the nodes of the network, in some particular embodiments, the fill color of the nodes also may be color-coded to indicate the health status of the node, e.g., how close the node is to a threshold volume. Again, as with the data for the edges, the status/color of the nodes may be selected as a function of either the traffic of all users of that node or just the traffic of the single user of interest. In certain embodiments, the user may be allowed to toggle between those two settings. In some particular examples, the threshold may be the over-all buffer volume capacity of the node (e.g., how many routes the router can hold at any given instant). In other examples, the threshold may be the buffer volume paid for by the particular customer (e.g., according to that customer's SLA).

In some particular embodiments, there may be four different colors, e.g., (1) green indicating that the volume is less than 80% of the threshold (and thus the node is considered healthy since there is still plenty of buffer capacity still available), (2) yellow indicating that the between 80% and 90% of the threshold is occupied with data (thus indicating that the buffer usage is approaching the threshold and perhaps needs attention), (3) orange indicating that the buffer usage is between 90% and 100% of the threshold (thus indicating that the buffer usage is approaching the threshold), and (4) red indicating that the buffer usage has surpassed the threshold (e.g., thus indicating a violation of the SLA and/or that the buffer has overflowed and packets may be getting dropped).

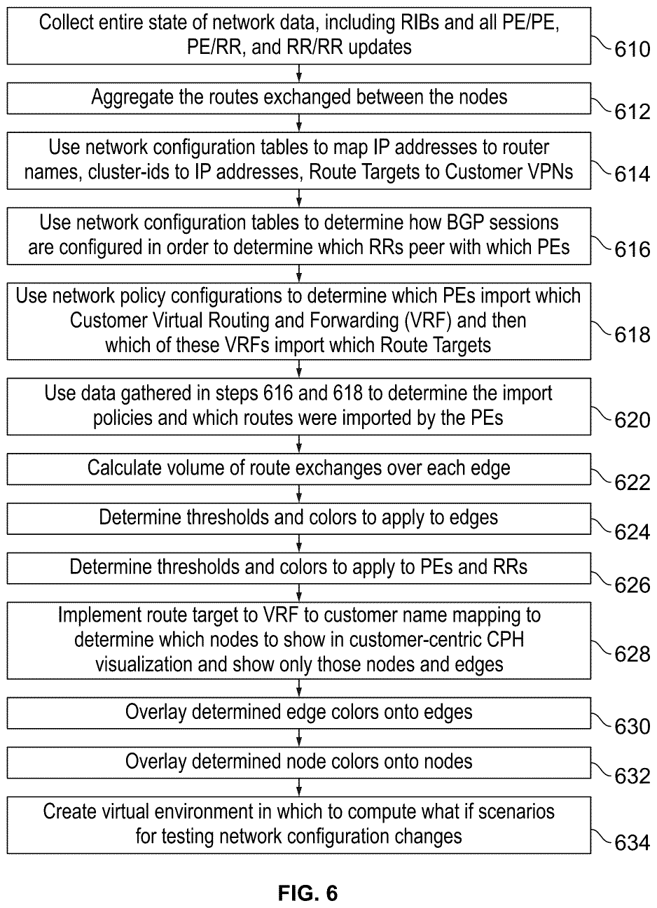

In certain embodiments, the user has the option to overlay the control plane highway visualization over a map wherein each node is shown overlying a location on the map corresponding to its physically located. See, for instance FIGS. 6A, 6G, and 6H, which show this feature and are discussed in greater detail further below.

In certain embodiments, the visualizations that do not show real-world geography, such as FIGS. 3 and 4, may already show the nodes in positions corresponding to their actual geographic positions on a map, but just without overlying a map. However, in other embodiments, switching from the non-geographic visualization to the geographic visualization may require modification of the positions of the nodes. Particularly, in some cases, if actual geographic location is not important to the user, then it may quite likely that the control plane highway visualization is easier to digest and more user-friendly if geographical location is ignored for purposes of the visualization. This might be the case, for instance, if a bunch of the nodes are clustered very close to each other geographically while a handful of other nodes are geographically distant from the cluster and/or each other. In such cases, if geography is not an important factor to the user, then there would be little point in showing a bunch of nodes close to each other and a few nodes very far away.

In other embodiments such as shown in FIG. 6B, the nodes may be presented in a hierarchical topological view. Depending on the goal of the user, a hierarchical view may be much more useful to the user than a geographical view.

In embodiments, the user may be allowed to switch between the different types of view at will, geographical, topological, user-friendly.

It should be apparent that the CPH visualization paradigm may be very useful in assisting a user in tracking down the source of network outages, poor or faulty performance in the network, and the like. For example, if a customer starts to experience dropped packets between two of its CE nodes that are connected via the ISPs network, an operator can generate a control plane highway visualization such as illustrated by FIG. 3 or FIG. 4 and quickly identify any edge(s) or router(s) in the path between those two customer nodes that are overloaded, and focus attention on those network elements, as they are likely the source of the problem.

The user can then click on any edge of interest or router of interest and be taken to a new GUI from which the user can see additional control plane data about that edge or router with further clickable links to even further data. Network analytics software is widely available commercially for determining, storing, and displaying all kinds of relevant control plane data about the individual edges and nodes of networks, down to details as fine as seeing lists of the actual prefixes being exported over a user-selectable period of time. Such types of data are well known in the relevant trades and, thus will not be discussed in detail in this disclosure, other than to say the Control Plane Highway interfaces to such analytics software so that such data can be called up for display by clicking on the individual edges and/or nodes in the control plane highway visualization to be shown additional GUIs for accessing such data. Merely as a few examples, clicking on an edge may call up a table that shows a list of all customers with control plane traffic on that edge, including, for instance, numbers of prefixes being advertised, lists of the prefixes, trends over time of each customer's usage of the bandwidth of the edge. Similar information may be obtained about individual routers shown in the Control Plane Highway visualization, such as buffer usage by each customer, trends of usage by each customer over time, etc.

In embodiments, AI/ML (Artificial Intelligence and/or Machine Learning) is used to track changes over time of various traffic parameters and show them to the user in graphical form (see, e.g., FIG. 6C discussed in more detail below). This might be useful information to a network analyst in terms of determining if there are predictable patterns to changes in traffic loads, which might be useful in determining when additional network resources may be brought online or taken offline in the network (e.g., for maintenance purposes or simply to save money during periods of low traffic).

In embodiments, the user may further customize the CPH view in many ways. For example, the user may request to see just the nodes that are in violation of a volume limit (e.g., (1) only the nodes that are red or (2) only the nodes that are any of yellow, orange and red or (3) the top ten nodes in violation of a threshold).

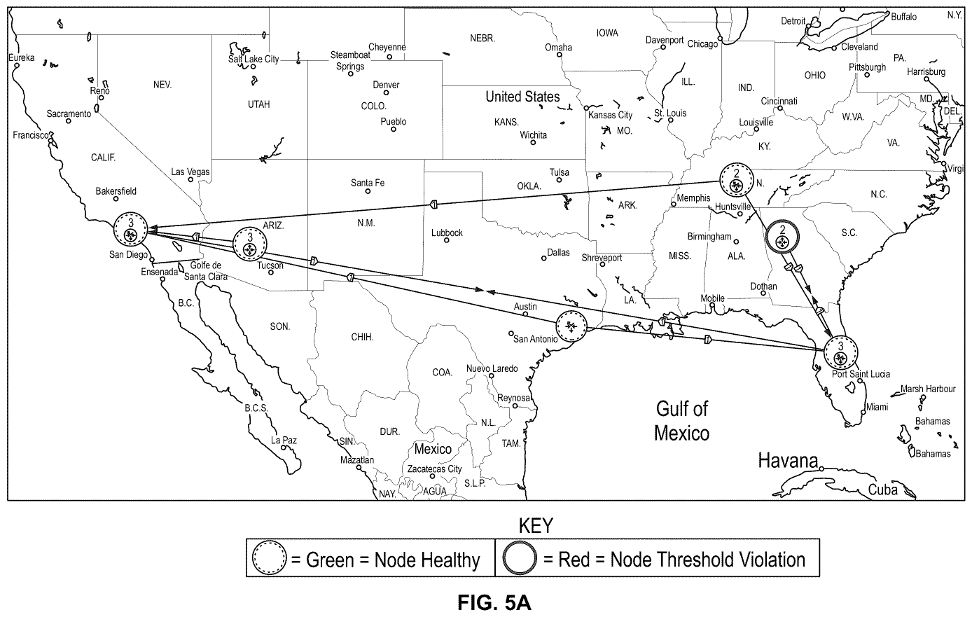

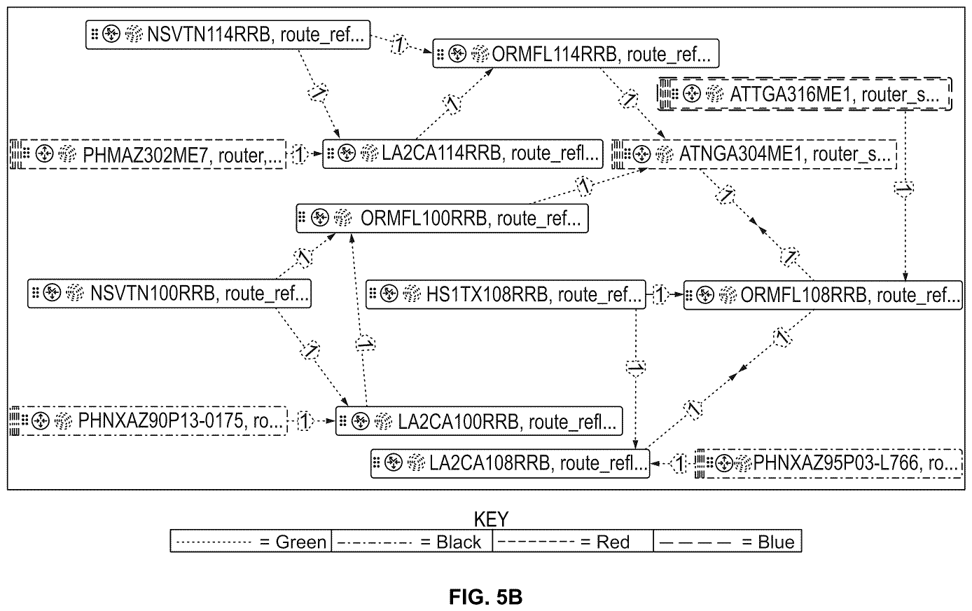

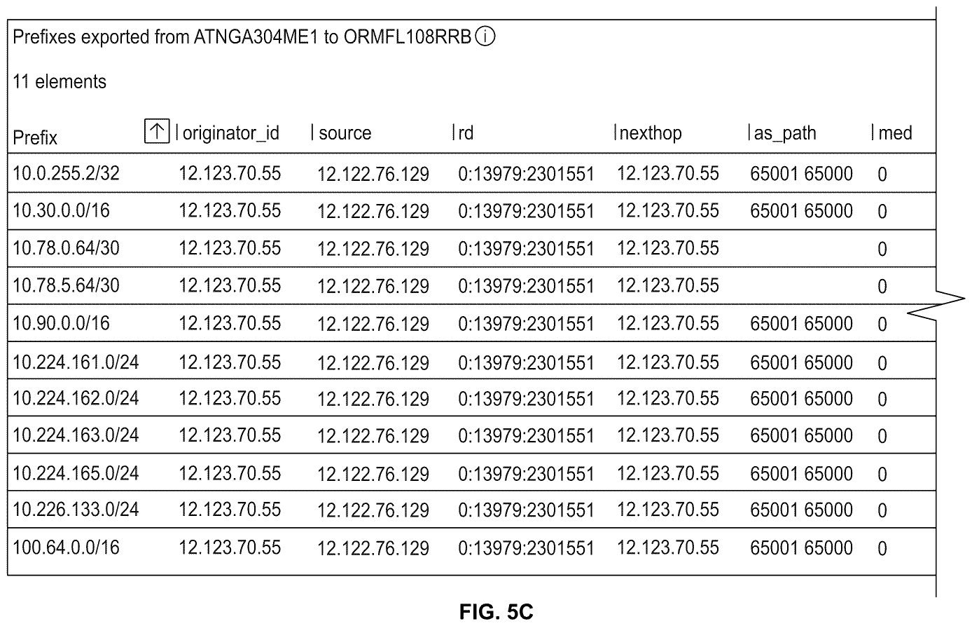

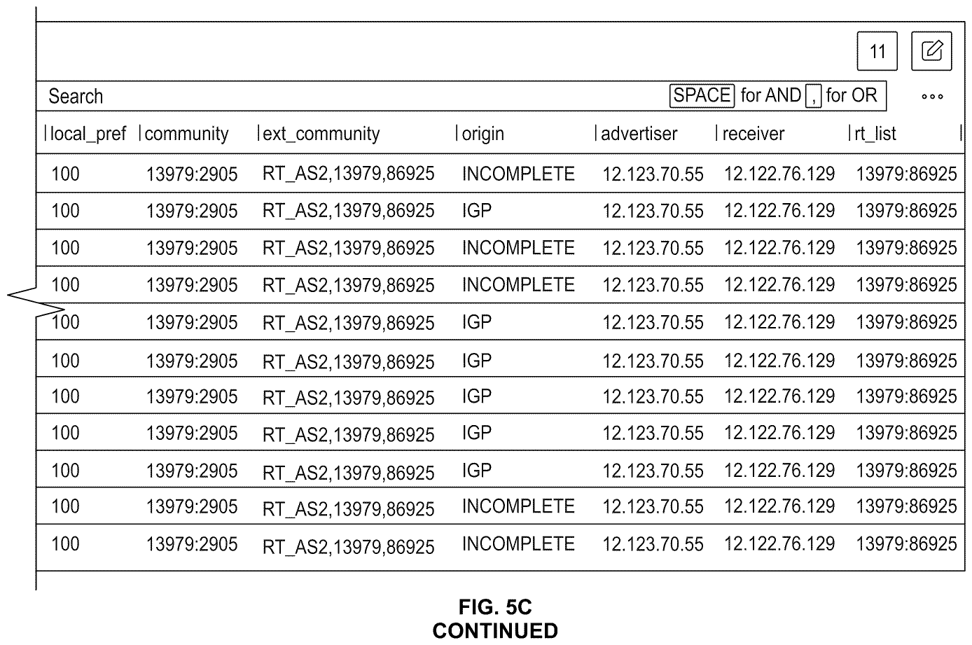

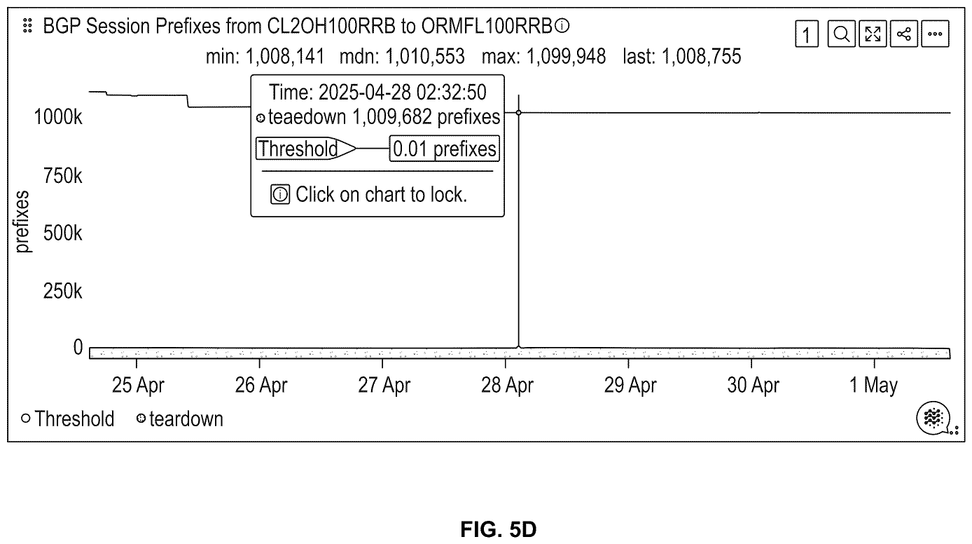

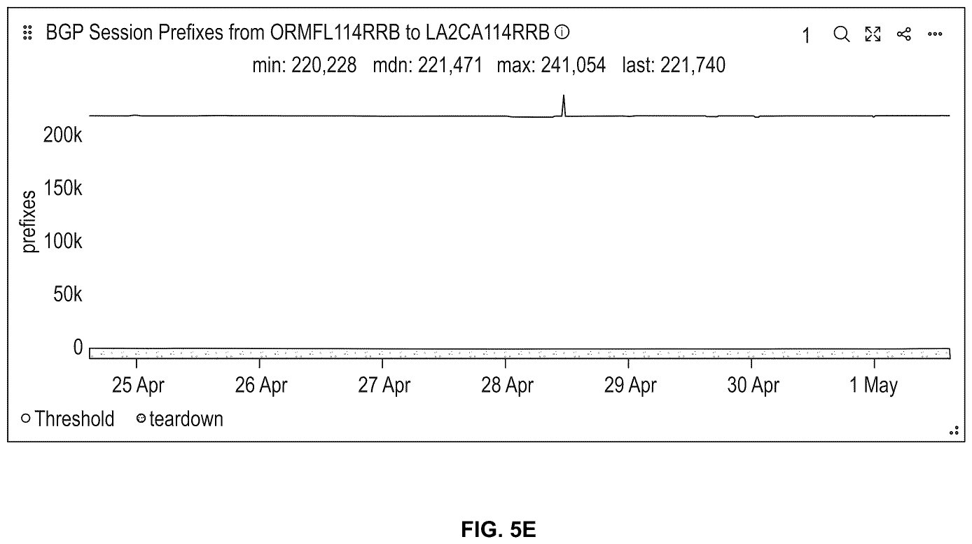

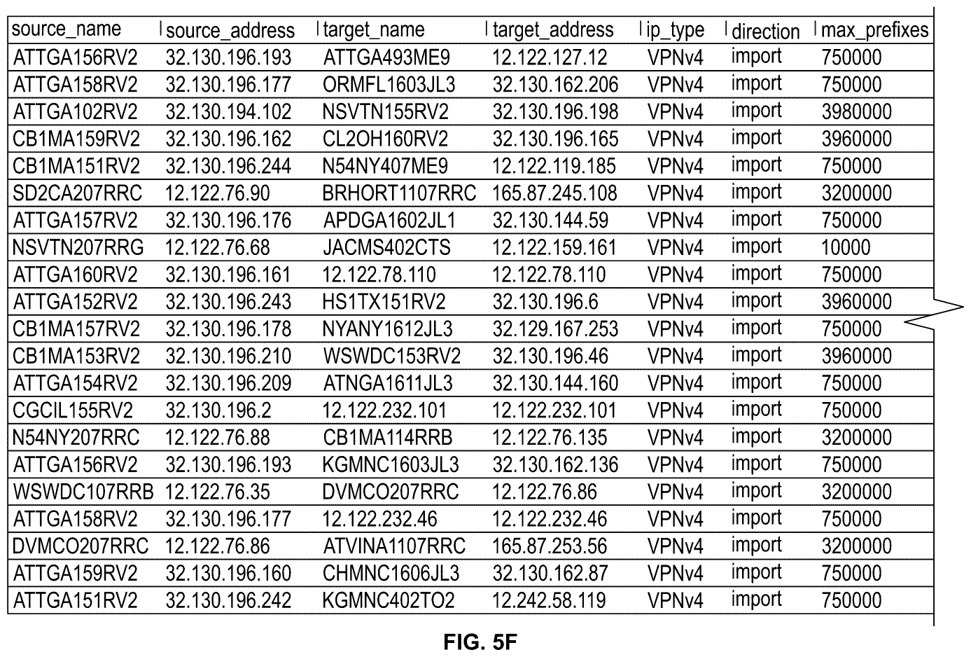

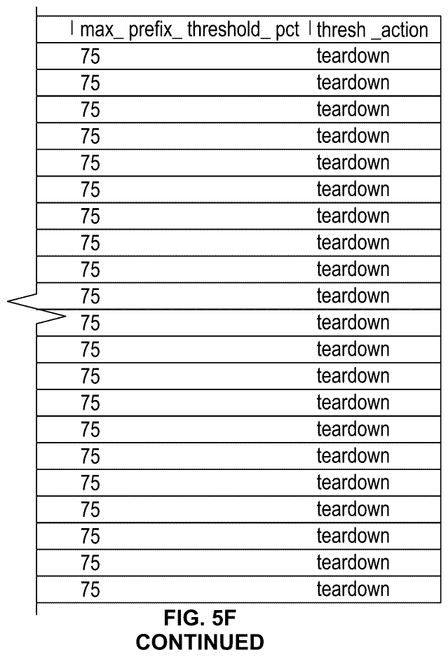

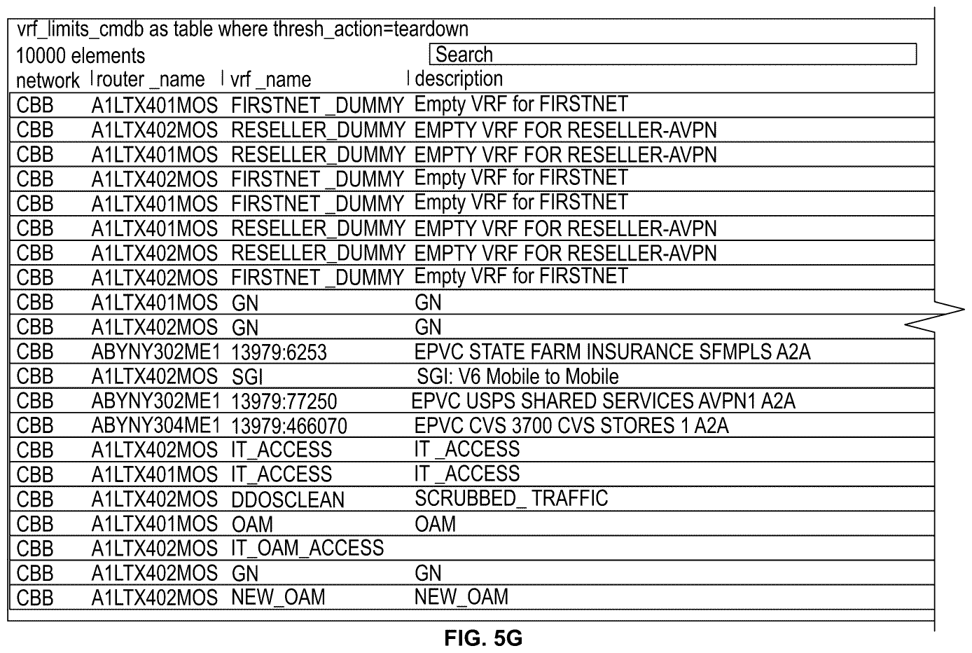

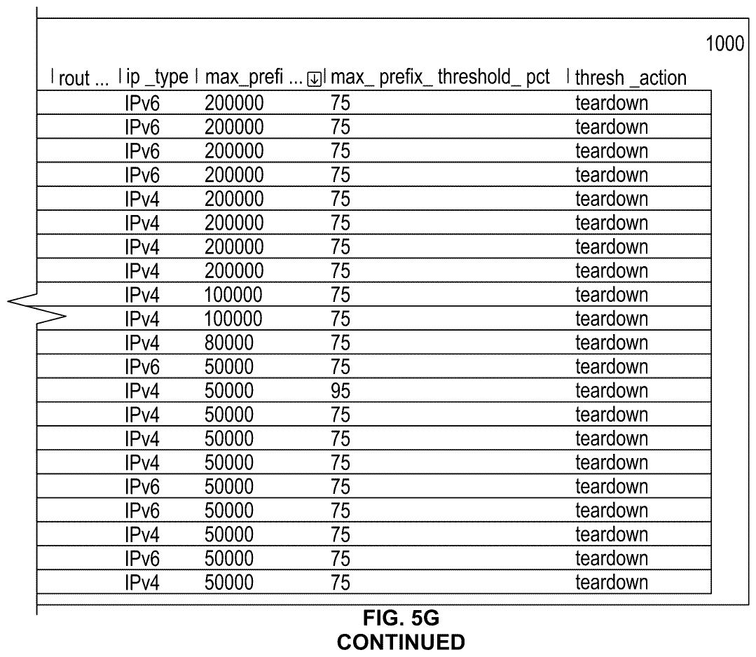

FIGS. 5A through 5L show examples of just a few of the additional GUIs that may be made accessible to the user via either clicking on an edge or router in the Control Plane Highway GUI or by selecting a menu option in the CPH GUI.

For instance, FIG. 5A illustrates the previously mentioned GUI in which the Control Plane Highway visualization is overlaid over a geographic map to illustrate the actual geographic locations of the nodes relative to each other and the world. As previously mentioned, this transformation onto a map may or may not require actual movement of the routers relative to each other in the non-geographic view such as shown in FIG. 4.

FIG. 5B illustrates the previously mentioned GUI in which the Control Plane Highway visualization is arranged to show the routers visually arranged to show the topological hierarchy of the routers. This type of view may be useful when geographical information is unavailable (or irrelevant to the analyzer's task at hand).

FIG. 5C shows a GUI that may be accessed by clicking on a particular edge in the CPH GUI (e.g., FIG. 4) which shows a table listing of all of the prefixes exported over that edge between two routers during a user-selectable time period, including additional information such as originator ID, source, nexthop, etc.

FIG. 5D illustrates a GUI that may be accessed by clicking on a particular edge in the CPH GUI showing the trend over a user-selectable time period of BGP session traffic volume. As seen in FIG. 5D, the user can click anywhere in the timeline to be presented with additional detail at the instant clicked on.

FIG. 5E illustrates a GUI similar to that of FIG. 5D, but in which a brief spike in BGP session traffic is seen at about 2-3 PM on April 28.

FIG. 5F illustrates a GUI in which the policy configuration of BGP session limits is shown.

FIG. 5G illustrates a GUI in which the Virtual Routing and Forwarding (VRF) RIB size limits per node and per customer are shown.

FIG. 6 is a flowchart illustrating operations in accordance with an exemplary embodiment for generating a CPH GUI such as shown in FIG. 4. It should be understood that there are almost countless ways to generate a CPH GUI depending on many factors, such as available control plane data, the source(s) of such data, design choices, etc. The following description is offered for illustrative purposes and is not limiting. The processes described in connection with FIG. 6 may be performed using software running on a general purpose or specialized computer.

In step 610, information as to the entire state of the network is collected from which the RIB for the entire network and the topology of the entire network can be known. This includes the RIBs of the network and any control plane updates that flow between the PEs, between the RRs, and between the PEs and RRs. As mentioned above, such data is readily available in various forms, including snapshots of the state of the network at certain instants in time and BGP update reports. Aforementioned U.S. patent application Ser. No. 18/434,963 and Ser. No. 18/600,223 disclose some possible techniques for collecting such data and building of a model of the network based on such data.

In step 612, the routes exchanged between any two RRs or between any PE and any RR are collected. Note that, if there are any direct exchanges of routes between two PEs in the network, that data will also be aggregated. However, since the basic concept behind the use of RRs in most networks is that all exchanges of routes between PEs occurs through RRs, there usually will not be any direct PE to PE exchanges. Accordingly, for purposes of this example, we shall assume that there are no PE to PE route exchanges.

A complete list of all actual exchanges is stored. Particularly, as previously noted, a user may click on an edge and be presented with the actual list of exchanges that occurred over that edge over some (preferably user selectable) period of time.

The route exchange data typically comes in the form of a list of prefixes. Thus, in order to make the data more user friendly, it is desirable to map the IP addresses to router names, etc. Accordingly, in step 614, the network configuration tables are consulted to map IP addresses to router names, to map cluster-ids to IP addresses, and to map Route Targets to customer VPNs. Thus, for instance, when the user clicks on an edge or router to get more detailed information about the routes exchanged over that link, the system can present the list of exchanged prefixes in a table that also includes for each exchanged route the information in more user friendly. For example, see FIG. 5L, in which each entry includes the router name and description (which might provide a clue to a human user as to the name and/or location of the relevant customer, rather than just a number which would likely be meaningless to the human user.

In step 616, if the data is not otherwise more readily available, then the network configuration tables may be consulted again to determine how BGP sessions are configured and which RRs peer with which PEs. More particularly, the network operator does not necessarily have visibility into the CEs, which belong to the customer and not to the network operator. Thus, some of the information needed to build the CPH may have to be derived from more indirect sources, such as the network configuration tables. However derived, this information is also used to determine the edges in the CPH (i.e., determine which RRs and PEs are talking to which other RRs and PEs).

In step 618, the network policy configuration is consulted to determine which PEs import which customer Virtual Routing and Forwarding (VRF), and then which of those VRFs import which Route Targets. This data also is used in determining the thickness of the edges in the CPH as well as the arrow directions.

In step 620, the information, if any, gathered in steps 612 618 is now used to determine the import policies between the two nodes at opposite ends of each edge and which routes were imported by the PEs.

In step 622, the system calculates the volume of route exchanges over each edge. In an embodiment, the volume of route exchanges between any two nodes may be aggregated both on a customer by customer basis and in the aggregate (all customers). The volume may be set as a function of the number of routes exchanged over some period of time prior to the present time (e.g., 10 milliseconds). In other embodiments, the thickness of the edge may be set as a function of the number of services that are presently advertised over that edge. As mentioned earlier, the thickness represents the total control plane traffic on that edge, rather than for any single customer.

In step 624, the overall volume of control plane traffic on each edge will be compared to the thresholds to determine what color should be assigned to each edge in the customer-centric CPH visualization.

In step 626, the volume of the buffer usage for route storage (or another metric, as the case may be) will be compared to that router's thresholds to determine what color should be assigned to each router in the customer-centric CPH visualization.

In step 628, the system determines the particular customer of interest and then implements route target to VRF to customer name mapping to determine which nodes to show in the customer-centric CPH visualization, and generates as display showing only those nodes and edges to visualize all the prefixes originating from various Points of Presence (PoPs) and the flow of this data along the shared infrastructure.

In step 630, the colors selected for the edges in step 624 are overlaid onto the customer-centric CPH visualization.

In step 632, the colors selected for the nodes in step 626 are overlaid onto the customer-centric CPH visualization.

Finally, in step 634, the system creates a virtual network based on the CPH visualization data and allows the user to play with the network parameters (e.g., change traffic loads on one or more edges, change buffer loads at one or more nodes, eliminate nodes, add nodes, change thresholds, change network policies, change configurations, etc.), and the system will update the colors of the nodes and edges and the edge thicknesses commensurately with the traffic/load/topology changes to show the effects of such changes in the visualization.

In embodiments, the user can electively retrieve the entire network state since the metrics like VRF limits and BGP sessions are common to all customers.

This system provides a flexible framework for distributing control state across diverse network environments from service provider infrastructures to enterprise networks, data centers, cloud architectures, and any complex routing ecosystem. While the specific exemplary embodiments discussed herein focus on Layer 3 routing information, that is merely one exemplary application of the concept, which can be used to visualize other types of control plane data such as Layer 2 VPN data or MAC (Media Access Control) addresses. The approach transcends traditional routing and layer 3 applications, enabling efficient exchange of various control states including L2 VPN MAC address tables and any large-scale table dissemination requirements, representing a paradigm shift from siloed control state management to a unified approach that maintains consistency across increasingly complex and hybrid network architectures.

The system transforms abstract routing information into an intuitive highway system mapped to geographic locations, making complex network architectures comprehensible. It aggregates distributed routing information from hundreds of devices across regions into a single, coherent visualization without requiring specialized query knowledge.

This system enables customer-centric filtering, offering the ability to filter hundreds of millions of routes to focus on specific customer paths and relationships within the larger network. It provides complete route journey visualization, showing the full path of routing information from origin through the hierarchical system to destination, with dynamic indicators for volume and health. It provides bi-directional protocol status, visualizing BGP session health and route exchange in both directions between network elements.

The hierarchical routing visualization option allows specific visualization of the route reflector hierarchy and its impact on route propagation throughout the network. It enables operators to identify potential bottlenecks and resource constraints before they impact service.

### Conclusion

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), quantum computer, and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Moreover, the claims should not be read as limited to the provided order or elements unless stated to that effect. In addition, use of the terms “means for” in any claim is intended to invoke 35 U.S.C. § 112, 16or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

1. A method of displaying customer-centric control plane information about a communication network comprising:
obtaining data defining the control state of the communication network;
selecting a customer of the network;
determining from the data defining the control state of the communication network a subset of the nodes of the network and a subset of the edges of the network being utilized in support of data of the selected customer;
generating a visual display of a portion of a topography of the network including visual representation of only the nodes of the network being utilized in support of data of the selected customer and visual representations of only the edges of the network that comprise connections between the displayed nodes;
with respect to each visual representation of an edge of the network, indicating via a first visual attribute of the visual representation of the edge a relative amount of control plane data flowing in the edge relative to the other edges in the display;
with respect to each visual representation of an edge of the network, indicating via a second visual attribute of the visual representation a level of the control plane data flowing in the edge relative to a first threshold; and
with respect to each visual representation of a node of the network, indicating via an attribute of the visual representation of the node a level of control plane data stored in the node.

2. The method of claim 1 wherein the attribute of the visual representation of the node indicative of the level of control plane data stored at the node comprises a color of the visual representation of the node.

3. The method of claim 2 wherein the color of the node represents the volume of control plane data stored at the node relative to a threshold volume of data.

4. The method of claim 3 wherein the volume of control plane data stored at the node that is used to select the color of the node is a total volume for all customers of the network.

5. The method of claim 1 wherein the visual representations of the edges of the network comprise lines, and wherein the first visual attribute of the edge comprises thickness of the line

6. The method of claim 5 wherein the second visual attribute of the edges of the network comprises color.

7. The method of claim 6 wherein the thickness of the line is set as a function of the total control plane traffic of all customers of the network through the corresponding edge.

8. The method of claim 7 wherein the color of the line is set as a function of total control plane traffic of all customers of the network in the corresponding edge.

9. The method of claim 8 wherein the visual representations of the edges of the network comprise a third visual attribute indicative of whether the edge forms a one way or a two way connection between two nodes of the network.

10. The method of claim 9 wherein the third visual attribute of the edges of the network comprises arrows at the ends of the lines.

11. The method of claim 10 wherein the color of the line comprises a color of a first portion of the line representing the volume of control plane traffic flowing in a first direction in the edge and comprises a color of a second portion of the line different from the first portion of the line representing the volume of control plane traffic flowing in a second direction in the edge.

12. The method of claim 11 wherein the volume of control plane traffic is determined as an average rate of control plane traffic over a predetermined period of time.

13. The method of claim 1 wherein the control plane data in the edges comprises routing information base (RIB) data.

14. The method of claim 1 wherein the control plane data stored in the nodes comprises routing information base (RIB) data.

15. The method of claim 1 further comprising embedding links in the visual representations of the nodes and edges whereby a user may select the links with a computer graphical pointer device, and wherein selection of a link causes the display of detailed control plane data relevant to the associated node or edge.

16. The method of claim 15 wherein selecting a link comprises clicking on the visual representation of the edge or node with a computer mouse.

17. The method of claim 1 wherein the amount of control plane data flowing in an edge is determined as an average number of route exchanges occurring over a period of time.

18. The method of claim 1 further wherein the level of control plane data stored in each node is determined as a function of an amount of memory used at the node to store routing information.

19. The method of claim 1 further comprising indicating a type of a node in the display via a third visual attribute of the visual representation of the node, wherein the third visual attribute is a color of a border of the visual representation of the node, and wherein the second visual attribute is a fill color of the visual representation of the node.

20. The method of claim 19 wherein the types of nodes represented by the third visual attribute include Provider Edge Routers (PEs), Reflector Routers (RRs), and Customer Edge Routers (CEs).
